(19) United States
(12) Patent Application Publication
(10) Pub. No.: US 2006/0086284 A1
(43) Pub. Date: Apr. 27, 2006

(54) Non-alkaline micronized wood preservative formulations

(76) Inventors: Jun Zhang, Getzville, NY (US); Robert M. Leach, Grand Island, NY (US)

Correspondence Address: HODGSON RUSS LLP, ONE M & T PLAZA, SUITE 2000, BUFFALO, NY, 14203-2391, US

(21) Appl. No.: 11/250,312

(22) Filed: Oct. 14, 2005

Related U.S. Application Data
(60) Provisional application No. 60/618,733, filed on Oct. 14, 2004.

(51) Int. Cl. C09D 5/14; B05D 3/12

(52) U.S. Cl. 106/15.05; 427/351

(57) ABSTRACT

Provided is a non-alkaline composition for the preservation of wood and other cellulosic materials. The composition comprises an aqueous dispersion of micronized inorganic compounds and/or organic biocides. Also provided is a method for making the composition.

This application claims priority to U.S. provisional application no. 60/618,733, filed on Oct. 14, 2004, the disclosure of which is hereby incorporated by reference.

### FIELD OF THE INVENTION

The present invention pertains to wood preservation, and more specifically to the use of micronized metals, metal compounds, and organic biocides as wood preservatives.

### BACKGROUND OF THE INVENTION

Wood preserving compositions are well known for preserving wood and other cellulose-based materials, such as paper, particleboard, textiles, rope, etc., against organisms responsible for the destruction of wood, such as, for example, microbes, fungi and insects. Many conventional wood preserving compositions contain copper ammine complexes. Copper ammine complexes have been used heretofore because of the ease with which ammonia solubilizes copper in aqueous solutions, forming such complexes. Copper is readily available from a variety of copper bearing materials, including copper scrap, cuprous and cupric oxides, copper carbonate, copper hydroxide, a variety of cuprous and cupric salts, and copper bearing ores. The ammonia used in the formation of copper ammine complexes is readily available as an aqueous ammonia solution, and/or as a solution formed by the dissolution of ammonium salts, such as ammonium carbonate, and ammonium sulfate, ethanolamines, et cetera. For example, U.S. Pat. No. 4,622,248 describes the formation copper amine complexes by dissolving copper (II) oxide [CuO] (cupric oxide) in ammonia in the presence of ammonium bicarbonate.

Ammonia has disadvantages as a copper solubilizing agent due to, among other things, its strong odor and the ability of copper ammonia preservatives to affect the appearance of the treated wood, giving surface residues an undesirable color.

In recent years, many amine-containing compounds, such as the ethanolamines and aliphatic polyamines, have been used to replace ammonia in the formulation of water-soluble copper solutions. These compounds have strong complexing ability with copper and they are essentially odorless. U.S. Pat. No. 4,622,248 discloses a method of preparing copper amine complexes by dissolving a mixture of copper (II) carbonate [CuCO₃] and copper (II) hydroxide [Cu(OH)₂] in ethanolamine and water. The complexing amine (i.e., the ligand) and copper (II) ion combine stoichiometrically. However, copper amine based preservatives have higher copper loss due to leaching compared to other traditional copper based preservatives such as more traditional amine/ammonia-free preservatives such as chromated copper arsenate (CCA).

In addition to metal biocides, existing wood preservatives can also contain organic biocides. However, many organic biocides currently in use are not water soluble. Therefore, solubilizing agents, surfactants and wetting agents are often added to either solubilize or form emulsions of the organic biocide in order to formulate a product that is suitable for the treatment of wood or other cellulose substrates. However, the solubilizing agents, surfactants, and wetting agents are costly and the use of these products may result in enhanced leaching of the organic biocides when the treated material comes into contact with moisture, giving rise to field performance problems or environmental issues.

Despite efforts to address these deficiencies in existing wood preservatives, there has been an unmet need for aqueous preservatives that are suitable for treating wood and other cellulose-based materials while minimizing the undesirable leaching of metal ions and/or organic biocides from treated materials when the materials are exposed to water.

### SUMMARY OF THE INVENTION

Provided are micronized compositions which are neutral or acid in pH. The present invention provides micronized compositions for preservation of wood wherein the pH of the compositions is neutral or acidic i.e., pH of less than or equal to about 7.0 with a preferred range of pH 5.0 to pH 7.0.

Accordingly, in one embodiment a wood preservative composition having a pH of 7.0 or less is provided comprising one or more micronized metals, metal compounds or combinations thereof.

In another embodiment an aqueous wood preservative composition having a pH of 7.0 or less is provided, comprising one or more micronized metals or metal compounds and one or more water-soluble organic biocides.

In another embodiment an aqueous wood preservative composition having a pH of 7.0 or less is provided, comprising one or more micronized metals or metal compounds and one or more micronized organic biocides.

In another embodiment an aqueous wood preservative composition having a pH of 7.0 or less is provided, comprising one or more micronized organic biocides.

In another embodiment an aqueous wood preservative composition having a pH of 7.0 or less is provided, comprising one or more micronized organic biocides, and one or more water-soluble metal compounds.

Also provided is a method for preserving cellulosic materials with the compositions of the present invention. The method comprises the step of impregnating a cellulosic material, such as wood, with a micronized composition of the present invention. When the compositions of the present invention are used for preservation of wood, minimal leaching of the micronized components from the wood upon exposure to the environment is generally observed.

In another embodiment, a preferred wood preservative composition is copper or a copper compound comprising particles in the form of a micronized dispersion comprising particles having sizes in the range of 0.001 microns to 25.0 microns. The dispersion can be present in the preservative composition with one or more water soluble and/or water insoluble organic biocides. The composition has a pH of 7.0 or less.

### BRIEF DESCRIPTION OF THE FIGURES

FIG. 1 depicts the anatomy of coniferous wood.

FIG. 2 depicts the border pit structure for coniferous wood.

### DETAILED DESCRIPTION OF THE INVENTION

The term “micronized” as used herein means a particle size in the range of 0.001 to 25 microns. Furthermore, it should be understood that “micronized” does not refer only to particles which have been produced by the finely dividing, such as by mechanical grinding, of materials which are in bulk or other form, but to particles in the foregoing size range, whether they are ground from larger stock, formed in situ, or formed by other methods. The term “preservative” as used herein refers to a composition which, upon application, increases the resistance of a cellulosic material to insect, fungal or microbial attack. The term “particle size” refers to the largest axis of the particle, and in the case of a generally spherical particle, the largest axis is the diameter. It should be understood that a “dispersion” of micronized particles as used herein encompasses situations in which particles are present with sizes outside the micronized range. However, it is preferred that greater than 80 weight percent of the particles have diameters in the micronized range, and even more preferred that greater than 60 wt % of the micronized particles have a size of between 0.05 to 1.0 microns.

The dissolution of inorganic components such as metal or metal compounds can often result in an alkaline composition. For example, in the case of aqueous solubilized copper, the alkalinity of the solution can be due to the use of ammonia and substituted ammonium compounds as solubilizing agents. However, micronized dispersions can also be alkaline. It has been noted that micronized copper carbonate or copper 8-hydroxyquinolate compositions generally have a pH in the range of from 7-9.

It may thus be necessary to include amounts of one or more acids in preparing compositions of the present invention in order to give a neutral or acid pH. A wide variety of acids can be used, as long as they do not significantly interfere with the desired performance of the wood preserving composition or the desired characteristics of the treated wood. Non-limiting examples of commonly available acids which can be used in the compositions of the present invention are boric acid, hydrochloric acid, carbonic acid, and sulfuric acid. Other acids, such as other mono- and diprotic acids are also suitable. Organic acids, such as acetic, propanoic, and larger acids can also be used. Diacids, such as, for example, succinic and malonic acids; and multi-acids, such as for example, citric acid, can be used. If desired, the aqueous compositions of the present invention can be acidified by sparging with carbon dioxide instead of or in addition to the use of an acid.

For the purposes herein, a component, either organic or inorganic, will generally be considered to have the ability to remain in the wood preservative composition as micronized particles without completely dissolving if the compound has a solubility of less than or equal to 0.5 g per 100 grams of carrier at 25° C. More preferred is a solubility of less than or equal to 0.11 g per 100 grams of carrier at 25° C.

Metals or metal compounds which can be used in the preservative compositions of the present invention in their elemental form or as compounds include transition elements (including the lanthanide and actinide series elements) such as copper, strontium, barium, arsenic, antimony, bismuth, lead, gallium, indium, thallium, tin, zinc, cadmium, silver, nickel, etc.

A preferred metal is copper. Accordingly, in one embodiment, copper or copper compounds are used. The copper or copper compounds such as cuprous oxide (a source of copper (I) ions), cupric oxide (a source of copper (II) ions), copper hydroxide, copper carbonate, basic copper carbonate, copper oxychloride, copper 8-hydroxyquinolate, copper dimethyldithiocarbamate, copper omadine, copper borate, copper residues (copper metal byproducts) or other suitable copper source can be used as micronized particles having a particle size between 0.001 microns to 25 microns.

The present invention includes compositions which comprise one or more organic biocides which may be water-soluble or micronized, depending upon the embodiment employed. In one embodiment, a water-soluble inorganic compound is used with a micronized organic biocide. A range of water-soluble inorganic components can be used. Examples of such are water-soluble copper compounds. In one embodiment, non-copper-containing water-soluble inorganic compounds can be used instead of or in addition to copper-containing biocides. Examples of such compounds are sodium fluoride, sodium borate, and boric acid.

The organic biocides useful in the present invention can be water soluble or water insoluble, depending upon the embodiment, and include fungicides, insecticides, moldicides, bactericides, algaecides etc., in well-known chemical classes such as, for example, azoles, quaternary ammonium compounds, borate compounds, fluoride compounds, with the provision that if the composition does not contain a micronized metal/metal compound component, the organic biocide is present in the carrier as micronized particles.

Non-limiting examples of generally water soluble organic biocides are quaternary ammonium compounds. Quaternary ammonium compounds that can be mixed with micronized metal formulations have the following structures: 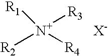
where R1, R2, R3, and R4 are independently selected from alkyl or aryl groups and X⁻ selected from chloride, bromide, iodide, carbonate, bicarbonate, borate, carboxylate, hydroxide, sulfate, acetate, laurate, or other anionic group. Preferred quaternary ammonium compounds include alkyldimethylbenzylammonium chloride, alkyldimethylbenzylammonium carbonate/bicarbonate, dimethyldidecylammonium chloride, dimethyldidecylammonium carbonate/bicarbonate, etc.

Non-limiting examples of preferred organic biocides are shown in Table I. In general, fungicides, insecticides and bactericides that can be used in the composition of the present invention include those known to one of skill in the art, and include azoles, quaternary ammonium compounds, boron compounds, fluoride compounds disclosed herein and combinations thereof. These compounds can be used in solubilized or micronized form, as their water solubility permits.

Examples of fungicides which can be used in the wood preservative formulations of the present invention are as follows:

TABLE I
aliphatic nitrogen fungicides, such as, for example:
butylamine; cymoxanil; dodicin; dodine; guazatine; iminoctadine
amide fungicides, such as, for example:
carpropamid; chloraniformethan; cyazofamid; cyflufenamid; diclocymet; ethaboxam;
fenoxanil; flumetover; furametpyr; prochloraz; quinazamid; silthiofam; triforine;
benalaxyl-M; furalaxyl; metalaxyl; metalaxyl-M; pefurazoate; benzohydroxamic acid;
tioxymid; trichlamide; zarilamid; zoxamide; cyclafuramid; furmecyclox dichlofluanid;
tolylfluanid benthiavalicarb; iprovalicarb; benalaxyl; benalaxyl-M; boscalid; carboxin;
fenhexamid; metalaxyl; metalaxyl-M; metsulfovax; ofurace; oxadixyl; oxycarboxin;
pyracarbolid; thifluzamide; tiadinil; benodanil; flutolanil; mebenil; mepronil;
salicylanilide; tecloftalam fenfuram; furalaxyl; furcarbanil; methfuroxam flusulfamide
antibiotic fungicides, such as, for example:
aureofungin; blasticidin-S; cycloheximide; griseofulvin; kasugamycin; natamycin;
polyoxins; polyoxorim; streptomycin; validamycin; azoxystrobin; dimoxystrobin;
fluoxastrobin; kresoxim-methyl; metominostrobin; orysastrobin; picoxystrobin;
pyraclostrobin; trifloxystrobin
aromatic fungicides, such as, for example:
biphenyl chlorodinitronaphthalene; chloroneb; chlorothalonil; cresol; dicloran;
hexachlorobenzene; pentachlorophenol; quintozene; sodium pentachlorophenoxide;
tecnazene
benzimidazole fungicides, such as, for example: s
benomyl; carbendazim; chlorfenazole; cypendazole; debacarb; fuberidazole; mecarbinzid
rabenzazole; thiabendazole
benzimidazole precursor fungicides, such as, for example:
furophanate; thiophanate; thiophanate-methyl
benzothiazole fungicides, such as, for example:
bentaluron; chlobenthiazone; TCMTB
bridged diphenyl fungicides, such as, for example:
bithionol; dichlorophen; diphenylamine
carbamate fungicides, such as, for example:
benthiavalicarb; furophanate; iprovalicarb; propamocarb; thiophanate; thiophanate-methyl;
benomyl; carbendazim; cypendazole; debacarb; mecarbinzid; diethofencarb
conazole fungicides, such as, for example:
climbazole; clotrimazole; imazalil; oxpoconazole; prochloraz; azaconazole; triflumizole
bromuconazole; cyproconazole; diclobutrazol; difenoconazole; diniconazole;
diniconazole-M; epoxiconazole; etaconazole; fenbuconazole; fluquinconazole; flusilazole
flutriafol; furconazole; furconazole-cis; hexaconazole; imibenconazole; ipconazole;
metconazole; myclobutanil; penconazole; propiconazole; prothioconazole; quinconazole;
simeconazole; tebuconazole; tetraconazole; triadimefon; triadimenol; triticonazole;
uniconazole; uniconazole-P
dicarboximide fungicides, such as, for example:
famoxadone; fluoroimide; chlozolinate; dichlozoline; iprodione; isovaledione; myclozolin;
procymidone; vinclozolin; captafol; captan; ditalimfos; folpet; thiochlorfenphim
dinitrophenol fungicides, such as, for example:
binapacryl; dinobuton; dinocap; dinocap-4; dinocap-6; dinocton; dinopenton; dinosulfon;
dinoterbon; DNOC
dithiocarbamate fungicides, such as, for example:
azithiram; carbamorph; cufraneb; cuprobam; disulfiram; ferbam; metam; nabam; tecoram
thiram; ziram; dazomet; etem; milneb; mancopper; mancozeb; maneb; metiram
polycarbamate; propineb; zineb
imidazole fungicides, such as, for example:
cyazofamid; fenamidone; fenapanil; glyodin; iprodione; isovaledione; pefurazoate;
triazoxide
morpholine fungicides, such as, for example:
aldimorph; benzamorf; carbamorph; dimethomorph; dodemorph; fenpropimorph;
flumorph; tridemorph
organophosphorus fungicides, such as, for example:
ampropylfos; ditalimfos; edifenphos; fosetyl; hexylthiofos; iprobenfos; phosdiphen;
pyrazophos; tolclofos-methyl triamiphos
oxathiin fungicides, such as, for example:
carboxin; oxycarboxin
oxazole fungicides, such as, for example:
chlozolinate; dichlozoline; drazoxolon; famoxadone; hymexazol; metazoxolon;
myclozolin; oxadixyl; vinclozolin
pyridine fungicides, such as, for example:
boscalid; buthiobate; dipyrithione; fluazinam; pyridinitril; pyrifenox; pyroxychlor;
pyroxyfur
pyrimidine fungicides, such as, for example:
bupirimate; cyprodinil; diflumetorim; dimethirimol; ethirimol; fenarimol; ferimzone;
mepanipyrim; nuarimol; pyrimethanil; triarimol
pyrrole fungicides, such as, for example:
fenpiclonil; fludioxonil; fluoroimide
quinoline fungicides, such as, for example:
ethoxyquin; halacrinate; 8-hydroxyquinoline sulfate; quinacetol; quinoxyfen;
quinone fungicides, such as, for example:
benquinox; chloranil; dichlone; dithianon
quinoxaline fungicides, such as, for example:
chinomethionat; chlorquinox; thioquinox
thiazole fungicides, such as, for example:
ethaboxam; etridiazole; metsulfovax; octhilinone; thiabendazole; thiadifluor; thifluzamide
thiocarbamate fungicides, such as, for example:
methasulfocarb; prothiocarb
thiophene fungicides, such as, for example:
ethaboxam; silthiofam
triazine fungicides, such as, for example:
anilazine
triazole fungicides, such as, for example:
bitertanol; fluotrimazole; triazbutil
urea fungicides, such as, for example:
bentaluron; pencycuron; quinazamid
Other fungicides, such as, for example:
acibenzolar; acypetacs; allyl alcohol; benzalkonium chloride; benzamacril; bethoxazin;
carvone; chloropicrin; DBCP; dehydroacetic acid; diclomezine; diethyl pyrocarbonate;
fenaminosulf; fenitropan; fenpropidin; formaldehyde; furfural; hexachlorobutadiene;
iodomethane; isoprothiolane; methyl bromide; methyl isothiocyanate; metrafenone;
nitrostyrene; nitrothal-isopropyl OCH; 2 phenylphenol; phthalide; piperalin; probenazole;
proquinazid; pyroquilon; sodium orthophenylphenoxide; spiroxamine; sultropen;
thicyofen; tricyclazole; methyl isothiocyanate
antibiotic insecticides, such as, for example:
allosamidin; thuringiensin; spinosad; abamectin; doramectin; emamectin; eprinomectin
ivermectin; selamectin; milbemectin; milbemycin oxime; moxidectin
botanical insecticides, such as, for example:
anabasine; azadirachtin; d-limonene; nicotine; pyrethrins; cinerins; cinerin I; cinerin II;
jasmolin; jasmolin II; pyrethrin I; pyrethrin II; quassia; rotenone; ryania; sabadilla
carbamate insecticides, such as, for example:
bendiocarb; carbaryl; benfuracarb; carbofuran; carbosulfan; decarbofuran; furathiocarb
dimetan; dimetilan; hyquincarb; pirimicarb; alanycarb; aldicarb; aldoxycarb;
butocarboxim; butoxycarboxim; methomyl; nitrilacarb; oxamyl; tazimcarb; thiocarboxime
thiodicarb; thiofanox; allyxycarb; aminocarb; bufencarb; butacarb; carbanolate;
cloethocarb; dicresyl; dioxacarb; EMPC; ethiofencarb; fenethacarb; fenobucarb;
isoprocarb; methiocarb; metolcarb; mexacarbate; promacyl; promecarb; propoxur;
trimethacarb; XMC; xylylcarb
dinitrophenol insecticides, such as, for example:
dinex; dinoprop; dinosam; DNOC; cryolite; sodium hexafluorosilicate; sulfluramid
formamidine insecticides, such as, for example:
amitraz; chlordimeform; formetanate; formparanate
fumigant insecticides, such as, for example:
acrylonitrile; carbon disulfide; carbon tetrachloride; chloroform; chloropicrin; para-
dichlorobenzene; 1,2-dichloropropane; ethyl formate; ethylene dibromide; ethylene
dichloride; ethylene oxide; hydrogen cyanide; iodomethane; methyl bromide;
methylchloroform; methylene chloride; naphthalene; phosphine; sulfuryl fluoride;
tetrachloroethane
insect growth regulators, such as, for example:
bistrifluron; buprofezin; chlorfluazuron; cyromazine; diflubenzuron; flucycloxuron;
flufenoxuron; hexaflumuron; lufenuron; novaluron; noviflumuron; penfluron;
teflubenzuron; triflumuron; epofenonane; fenoxycarb; hydroprene; kinoprene;
methoprene; pyriproxyfen; triprene; juvenile hormone I; juvenile hormone II; juvenile
hormone III; chromafenozide; halofenozide; methoxyfenozide; tebufenozide; α-ecdysone;
ecdysterone; diofenolan; precocene I; precocene II; precocene III; dicyclanil
nereistoxin analogue insecticides, such as, for example:
bensultap; cartap; thiocyclam; thiosultap; flonicamid; clothianidin; dinotefuran;
imidacloprid; thiamethoxam; nitenpyram; nithiazine; acetamiprid; imidacloprid;
nitenpyram; thiacloprid
organochlorine insecticides, such as, for example:
bromo-DDT; camphechlor; DDT; pp′-DDT; ethyl-DDD; HCH; gamma-HCH; lindane;
methoxychlor; pentachlorophenol; TDE; aldrin; bromocyclen; chlorbicyclen; chlordane;
chlordecone; dieldrin; dilor; endosulfan; endrin; HEOD; heptachlor; HHDN; isobenzan;
isodrin; kelevan; mirex
organophosphorus insecticides
bromfenvinfos; chlorfenvinphos; crotoxyphos; dichlorvos; dicrotophos; dimethylvinphos;
fospirate; heptenophos; methocrotophos; mevinphos; monocrotophos; naled; naftalofos;
phosphamidon; propaphos; schradan; TEPP; tetrachlorvinphos; dioxabenzofos;
fosmethilan; phenthoate; acethion; amiton; cadusafos; chlorethoxyfos; chlormephos;
demephion; demephion-O; demephion-S; demeton; demeton-O; demeton-S; demeton-
methyl; demeton-O-methyl; demeton-S-methyl; demeton-S-methylsulphon; disulfoton;
ethion; ethoprophos; IPSP; isothioate; malathion; methacrifos; oxydemeton-methyl;
oxydeprofos; oxydisulfoton; phorate; sulfotep; terbufos; thiometon; amidithion;
cyanthoate; dimethoate; ethoate-methyl; formothion; mecarbam; omethoate; prothoate;
sophamide; vamidothion; chlorphoxim; phoxim; phoxim-methyl; azamethiphos;
coumaphos; coumithoate; dioxathion; endothion; menazon; morphothion; phosalone;
pyraclofos; pyridaphenthion; quinothion; dithicrofos; thicrofos; azinphos-ethyl; azinphos-
methyl; dialifos; phosmet; isoxathion; zolaprofos; chlorprazophos; pyrazophos;
chlorpyrifos; chlorpyrifos-methyl; butathiofos; diazinon; etrimfos; lirimfos; pirimiphos-
ethyl; pirimiphos-methyl; primidophos; pyrimitate; tebupirimfos; quinalphos; quinalphos-
methyl; athidathion; lythidathion; methidathion; prothidathion; isazofos; triazophos;
azothoate; bromophos; bromophos-ethyl; carbophenothion; chlorthiophos; cyanophos;
cythioate; dicapthon; dichlofenthion; etaphos; famphur; fenchlorphos; fenitrothion;
fensulfothion; fenthion; fenthion-ethyl; heterophos; jodfenphos; mesulfenfos; parathion;
parathion-methyl; phenkapton; phosnichlor; profenofos; prothiofos; sulprofos;
temephos; trichlormetaphos-3; trifenofos; butonate; trichlorfon; mecarphon; fonofos;
trichloronat; cyanofenphos; EPN; leptophos; crufomate; fenamiphos; fosthietan;
mephosfolan; phosfolan; pirimetaphos; acephate; isocarbophos; isofenphos;
methamidophos; propetamphos; dimefox; mazidox; dimefox; mazidox; mipafox
oxadiazine insecticides, such as, for example:
indoxacarb
phthalimide insecticides, such as, for example:
dialifos; phosmet; tetramethrin
pyrazole insecticides, such as, for example:
acetoprole; ethiprole; fipronil; tebufenpyrad; tolfenpyrad; vaniliprole
pyrethroid insecticides, such as, for example:
acrinathrin; allethrin; bioallethrin; barthrin; bifenthrin; bioethanomethrin; cyclethrin;
cycloprothrin; cyfluthrin; beta-cyfluthrin; cyhalothrin; gamma-cyhalothrin; lambda-
cyhalothrin; cypermethrin; alpha-cypermethrin; beta-cypermethrin; theta-cypermethrin;
zeta-cypermethrin; cyphenothrin; deltamethrin; dimefluthrin; dimethrin; empenthrin;
fenfluthrin; fenpirithrin; fenpropathrin; fenvalerate; esfenvalerate; flucythrinate;
fluvalinate; tau-fluvalinate; furethrin; imiprothrin; permethrin; metofluthrin;
biopermethrin; transpermethrin; phenothrin; prallethrin; profluthrin; pyresmethrin;
resmethrin; bioresmethrin; cismethrin; tefluthrin; terallethrin; tetramethrin; tralomethrin;
transfluthrin; etofenprox; flufenprox; halfenprox; protrifenbute; silafluofen
pyrimidinamine insecticides, such as, for example:
flufenerim; pyrimidifen
pyrrole insecticides, such as, for example:
chlorfenapyr
tetronic acid insecticide, such as, for example:
spiromesifen
thiourea insecticides, such as, for example:
diafenthiuron
urea insecticide, such as, for example:
flucofuron; sulcofuron
Other insecticides, such as, for example:
closantel; crotamiton; EXD; fenazaflor; fenoxacrim; hydramethylnon; isoprothiolane;
malonoben; metoxadiazone; nifluridide; pyridaben; pyridalyl; rafoxanide; triarathene;
triazamate
Bactericides, such as, for example:
bronopol, 2-(thiocyanatomethylthio) benzothiazole (busan), cresol, dichlorophen,
dipyrithione; dodicin; fenaminosulf; formaldehyde; hydrargaphen; 8-hydroxyquinoline
sulfate; kasugamycin; nitrapyrin; octhilinone; oxolinic acid; oxytetracycline;
probenazole; streptomycin; tecloftalam; thiomersal

Isothiazolone-type bactericides such as, for example, Kathon 930, Kathon WT, Methylisothiazolinone, Benzisothiazolin-3-one and 2-octyl-3-isothiazolone may be used.

Some preferred organic biocides are listed in Table II below.

TABLE II
Organic Biocides Useful for Wood Protection

| Name | Formula and CAS# |
|---|---|
| Azoles: | |
| Cyproconazole | C₁₅H₁₈ClN₃O: 94361-06-5 |
| Propiconazole | C₁₅H₁₇Cl₂N₃O₂: 60207-90-1 |
| Tebuconazole | C₁₆H₂₂ClN₃O: 107534-96-3 |
| Busan (TCMTB) | |
| 2-(thiocyanatomethylthio) | C₉H₆N₂S₃: 21564-17-0 |
| benzothiazole | |
| Chlorothalonil | C₈Cl₄N₂: 1897-45-6 |
| Dichlofluanid | C₉H₁₁Cl₂FN₂O₂S₂: 1085-98-9 |
| Isothiazolone: | |
| Kathon 930 | C₁₁H₁₇Cl₂NOS: 64359-81-5 |
| Kathon WT | C₄H₄ClNOS: 26172-55-4 |
| Methylisothiazolinone | C₄H₅NOS: 2682-20-4 |
| Benzisothiazolin-3-one | C₇H₅NOS: 2634-33-5 |
| 2-octyl-3-isothiazolone | C₁₁H₁₉NOS: 26530-20-1 |
| Imidacloprid | C₉H₁₀ClN₅O₂: 138261-41-3 |
| Iodopropynyl Butylcarbamate | C₈H₁₂INO₂: 55406-53-6 |
| (IPBC) | |
| Pyrethroids: | |
| Bifenthrin | C₂₃H₂₂ClF₃O₂: 82657-04-3 |
| Cypermethrin | C₂₂H₁₉Cl₂NO₃: 52315-07-8 |
| Permethrin | C₂₁H₂₀Cl₂O₃: 52645-53-1 |
| Chitin | 1398-61-4 |
| Chitosan | 9012-76-4 |
| Clorpyrifos | C₉H₁₁Cl₃NO₃PS: 2921-88-2 |
| 4-cumylphenol | C₁₅H₁₆O: 599-64-4 |
| Fipronil | C₁₂H₄Cl₂F₆N₄OS: 120068-37-3 |
| Carbendazim | C₉H₉N₃O₂: 10605-21-7 |
| Cyfluthrin | C₂₂H₁₈Cl₂FNO₃: 68359-37-5 |
| 4-alpha-Cumylphenol | C₁₅H₁₆O: 599-64-4 |

Other biocides such as mold inhibitors, algaecides, and the like may also be added to the composition of the present invention.

Compositions which contain extremely high weight percent of micronized particles may be of high viscosity, and may require measures such as high pressures to ensure penetration. However, it is within the abilities of one skilled in the art to dilute the composition or otherwise reduce the concentration of micronized component if excessive viscosity prevents or inhibits penetration. As a rule, compositions having a micronized particle wt % in excess of 50 wt % may require the use of high pressures to achieve significant penetration. However, a concentrate which is intended for dilution before use may have a wt % of micronized particles which is much higher than 50 wt %.

The compositions of the present invention can be prepared and stored as a concentrate, if desired, which can be diluted with water to give the proper concentration for applying to wood. In general, the wood preservative composition can have a micronized particle wt % as high as 85 wt % or as low as 0.00001 wt %. The foregoing range encompasses both ready-to-apply compositions as well as concentrates.

The non-alkaline compositions of the present invention are generally aqueous or partially aqueous compositions. It can be desirable to use components in addition to water in order to enhance the performance of the wood preservative composition. For example, components other than water may be used to facilitate the solvation of either the inorganic component or the organic biocide component, if such a component is included. Components such as dispersants, defoamers, weathering agents, colorants, etc. may be included.

The ambit of the present invention includes the use of the above compounds and biocides in micronized form. The term “micronized” as used herein means a particle size in the range of 0.001 to 25 microns. The micronized particles can be obtained by wetting/dispersing and grinding the inorganic compounds, with or without organic carriers, using a grinding mill. However, it should be understood that “micronized” does not refer only to particles which have been produced by the finely dividing, such as by mechanical grinding, of materials which are in bulk or other form, but to particles in the foregoing size range, whether they are ground from larger stock, precipitated out of solution, formed using nanotechnological methods, formed in situ, etc.

It is preferred that the particles be formed in the presence of dispersants, such as stabilizers, wetting agents, surfactants, etc., such that a stable particle dispersion is formed. Standard dispersants can be used, such as acrylic copolymers, polymers with pigment affinic groups or other modifications which give them affinity for the micronized component(s) (“modified”). Other dispersants are modified polyacrylate, acrylic polymer emulsions, modified lignin, organically modified polysiloxane, modified polyurethane, polycarboxylate ether, modified fatty acids and fatty acid esters, modified polyether, modified polyamides, and the like.

The preservative compositions of the present invention can be prepared in a variety of ways. The component or components which are to be present as micronized particles in the preservative solution (the “solid component”) can be added to the solvent as micronized particles, or they can be added to some or all of the liquid phase components as large particulate or other solid form before grinding the particles to micronized size. If required to achieve a pH of 7 or less, one or more acids can be added to one or more liquid phase components, prior to, during or after the addition of solid components. Solid components can be added as large particulate for later grinding, or as micronized particulate. If the metal/metal compounds are added to the liquid phase component prior to micronization, an acid can be added before, during or after micronization.

The micronized particles can be obtained by wetting/dispersing and grinding solid components using a commercially available grinding mill in the absence or presence of a solution. Smaller particle size can often be achieved by dry-grinding. Alternatively, micronized compounds may also be purchased from commercial sources and ground further, in the absence or presence of a solution, if needed.

While many metal salts and compounds have a minimal effect on the pH of the composition, the addition of others may result in an increased or decreased pH with respect to the pH in their absence. It is preferred that the composition to be applied to the wood, including additives (micronized and non-micronized), have a pH of 7.0 or less. The addition of one or more acids may be necessary to achieve such conditions if pH-affecting additives are present.

In an embodiment in which multiple micronized compounds are to be present, such as, for example, micronized metal or metal compounds and water-insoluble micronized organic biocide, the compounds may be micronized separately and then mixed or mixed first and then micronized.

The compositions of the present invention may further comprise additives, i.e., micronized or non-micronized components such as water repellants, (such as wax emulsions) anti-weathering agents, wood stabilizing agents, colorants, emulsifying agents, dispersants, stabilizers, UV inhibitors, enhancing agents (such as trialkylamine oxides and alkoxylated diamines) and the like further enhance the performance of the wood preservative composition or the appearance and performance of the resulting treated products. The water insoluble inorganic/organic pigments, water repellants, anti-weathering agents, dimensional stabilization agents, and fire retardants, etc. and mixtures or synergistic mixtures thereof are well known to those skilled in the art. One of skill in the art will recognize that such additives may also have biocidal properties.

Some non-limiting examples of water insoluble inorganic and organic pigments are: iron oxide, iron hydroxide, calcium carbonate, calcium phosphate, calcium oxide, calcium hydroxide, bismuth oxide, bismuth hydroxide, bismuth carbonate, copper carbonate, copper hydroxide, basic copper carbonate, silicon oxide, zinc carbonate, barium carbonate, barium hydroxide, strontium carbonate, zinc oxide, zinc phosphate, zinc chromate, barium chromate, chrome oxide, titanium dioxide, zinc sulfide, antimony oxide, the phthalocyanine pigments, such as cobalt phthalocyanine, copper phthalocyanine, copper semichloro or monochlorophthalocyanine, copper phthalocyanine, metal-free phthalocyanine, copper polychlorophthalocyanine, etc. organic azo compounds, organic nitro compounds, polycyclic compounds, such as phthalocyanine pigments, quinacridone pigments, perylene and perinone pigments, diketopyrrolo-pyrrole(DPP) pigments, thioindigo pigments, dioxazine pigments, quinophthalone pigments, triacrylcarbonium pigments, etc.

Some non-limiting examples of water insoluble water repellents include paraffin wax, olefin wax, petroleum wax, carnauba wax, polyethylene wax, silicone wax, polypropylene wax, PTFE wax and synthetic wax, etc.

Some non-limiting examples of water insoluble anti-weathering agents are: Pigments such as zinc oxide, zinc sulfide, iron oxide, carbon black, titanium dioxide; UV absorbers such as hydroxyl-substituted benzophenones, hydroxyphenyl benzotriazdes, and substituted acrylonitriles; UV stabilizers such as hindered amine light stabilizers (HALS); anti-oxidants such as amines, imidiazoles or complex hindered phenolics.

Some non-limiting examples of water insoluble dimensional stabilization agents include waxes such as paraffin wax, olefin wax, petroleum wax, carnauba wax, polyethylene wax, silicone wax, polypropylene wax, PTFE wax and synthetic wax, and polymers such as polystyrene, polyethylene, polypropylene, polyvinyl chloride, polyacrylonitrile, polyvinyl acetate, polyester, acrylic polymers, polyamide, polyurethane, phenolic novolacs, phenolic resoles, urea formaldehyde resins, melamine formaldehyde resins, epoxy resins, natural resins such as rosin and rosin esters, hydrocarbon resins, ketone resins, terpene resins, alkyd resins, silicone resins and silicate resins, and any other water insoluble polymers

Some non-limiting examples of water insoluble fire retardants are: metal hydroxides such as aluminum trihydroxide and magnesium hydroxide; antimony compounds such as antimony trioxide, antimony pentoxide and calcium antimonite; zinc compounds such as zinc stannate, zinc hydroxyl-stannate, zinc borate, zinc silicate, zinc phosphate, zinc oxide and zinc hydroxide; phosphorous based compounds such as phosphate esters red phosphorus melamine phosphate, zinc phosphate, calcium phosphate, magnesium phosphate and ethylenediamine phosphate; silicate compounds such as calcium silicate, silica, magnesium silicate and zinc silicate; halogenated compounds such as tetra bromo bisphenol A; nitrogen based compounds such as melamine and its salts, melamine borate and polyamides, and so on.

While many of the above additives are water-insoluble, the ambit of the present invention includes water-soluble members of the above classes.

The trialkylamine oxides which can be used in the compositions of the present invention as enhancing agents have the following structure. 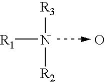
where R₁ is a linear or cyclic C₈ to C₄₀ having a degree of saturation which or unsaturated group and R₂ and R₃ independently are linear C₁ to C₄₀ saturated or unsaturated groups.

The alkoxylated diamines have the following structure: 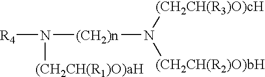
where n is an integer which can vary from 1 to 4, R₁, R₂ and R₃ are independently selected from the group consisting of hydrogen, methyl, ethyl and phenyl, and a, b and c are each integers which can be 1 to 6, and R₄ is fatty alkyl group of C₈ to C₂₂.

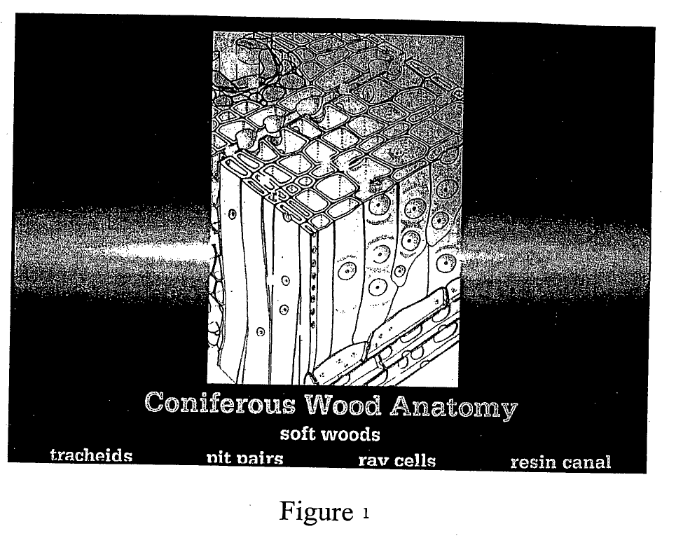

Also important is the penetration of the dispersion formulation into the cellular structure of the wood or other cellulose-based material. If the copper source used in formulating the dispersion formulation disclosed herein has a particle size in excess of 25 microns, the particles may be filtered by the surface of the wood and thus may not be uniformly distributed within the cell and cell wall. As shown in FIG. 1, the primary entry and movement of fluids through wood tissue occurs primarily through the tracheids and border pits. Tracheids have a diameter of about thirty microns. Fluids are transferred between wood cells by means of border pits.

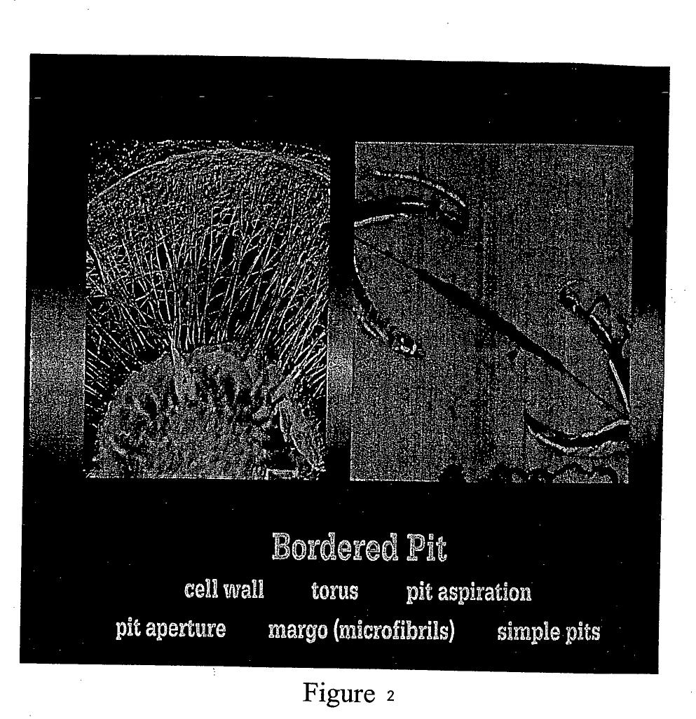

The overall diameter of the border pit chambers typically varies from a several microns up to thirty microns while, the diameter of the pit openings (via the microfibrils) typically varies from several hundredths of a micron to several microns. FIG. 2 depicts the border pit structure for coniferous woods.

When wood is treated with the preservative formulations of the present invention, if the particle size of the micronized preservative is less than the diameter of the pit openings, a complete penetration and a uniform distribution of micronized preservative in wood is expected as is demonstrated in examples 6-14.

Particle size of the metal, metal compounds or organic biocide used in the dispersion formulation disclosed herein typically does not exceed 25.0 microns or the metal and or organic biocide used in conjunction with the metal tends to be filtered by the surface of the wood thus not attaining a desired penetration and fluid flow through the wood tissue. In one embodiment particle size of the micronized particles used in the dispersion formulation disclosed herein can be between 0.005-10 microns. In another embodiment, the particle size is between 0.005 to 1.0 micron. In another embodiment, the particle size is between 0.05 to 10.0 microns. If a more uniform penetration is desired, particle size of the metal/metal compounds or the organic biocide used in the dispersion formulation disclosed herein can be between 0.05-1.0 microns.

Particles which are too large can clog the wood, preventing it from taking in other particles and particles which are too small can leach from the wood. Thus particle size distributional parameters can affect the uniformity of particle distribution in the wood, as well as the leaching properties of treated wood. It is thus preferable, but not essential, to use particle size distributions which contain relatively few particle sizes outside the range of 0.001 to 25 microns. It is preferred that no more than 20 weight percent of the particles have diameters which are greater than 25 microns. Because smaller particles have an increased chance of leaching from the wood, it is also preferred that no more than 20 wt % of the particles have diameters under 0.001 microns. Regardless of the foregoing recommendations, it is generally preferred that greater than 80 wt % of the particles have a diameter in the range of 0.001 to 25 microns. In more preferred embodiments, greater than 85, 90, 95 or 99 wt percent particles are in the range of 0.001 to 25 microns.

For increased degree of penetration and uniformity of distribution, at least 50 wt % of the particles should have diameters which are less than 10 microns. More preferred are particle distributions which have at least 65 wt % of the particles with sizes of less than 10 microns. In additional embodiments, less than 20 wt % of the particles have diameters of less than 1 micron.

The present invention also provides a method for preservation of wood. In one embodiment, the method comprises the steps of treating wood with a composition (treating fluid) comprising a dispersion of micronized metal/compounds and/or organic biocides. In another embodiment, wood is treated with a composition comprising a dispersion of micronized metal and/or metal compounds, the composition additionally comprising one or more soluble organic biocides. In another embodiment, wood is treated with a composition comprising a dispersion of micronized organic biocides, the composition additionally comprising one or more soluble metal and/or metal compounds.

The treating fluid may be applied to wood or other cellulosic materials by vacuum, pressure or dip impregnation, dipping, soaking, spraying, brushing, or other means known in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are well known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping). of the necessary intensity and duration. In the “Modified Full Cell”, prior to introduction of preservative, materials are subjected to a vacuum of less than 77 kPa (22 inch Hg) (sea level equivalent). A final vacuum of not less than 77 kPa (22 inch Hg) (sea level equivalent) shall be used. In the “Full Cell Process”, prior to introduction of preservative or during any period of condition prior to treatment, materials are subjected to a vacuum of not less than 77 kPa (22 inch Hg). A final vacuum of not less than 77 kPa (22 inch Hg) is used.

The following examples are provided to further describe certain embodiments of the invention but are in no way meant to limit the scope of the invention. Examples 1 through 5 demonstrate the formulation of the concentrated dispersions of copper compounds and the concentrated dispersions of copper compounds comprising various organic biocides. Examples 6 through 14 demonstrate the preparation of treating fluids using concentrated dispersions for the treatment of wood. The pH of all examples is between 5 and 7.

### EXAMPLE 1

500 g of copper hydroxide and 100 g dehydroacetic acid were added to a container containing 991.7 grams of water and 75.0 grams of commercially available dispersants/wetting agents. The mixture was mechanically stirred for 5 minutes and then placed in a grinding mill. The sample was ground for about 30 minutes, and a stable dispersion containing about 30% copper hydroxide was obtained. The particle size of the copper hydroxide dispersion was analyzed by Horiba LA-910 Particle Size Distribution Analyzer (PSDA). The average particle size was 0.195 micrometers (μm) with a distribution range of 0.04 μm to 1.5 μm.

### EXAMPLE 2

1000 grams of basic copper carbonate was mixed with 1908.3 grams of water and 175.0 grams of commercially available wetting agents/dispersants and then 250.0 g boric acid was added to the mixture. The mixture was mechanically stirred for 10 minutes. The mixture was then placed in a grinding mill and ground for about 20 minutes. A stable dispersion of basic copper carbonate was obtained with an average particle size of 0.199 micrometers.

### EXAMPLE 3

1000 grams of basic copper carbonate and 20 grams of were mixed with 3780 grams of water and 200 grams of wetting agents/dispersants. The mixture was mechanically stirred for about 10 minutes. The mixture was then placed in a grinding mill and ground for about 30 minutes. A stable dispersion containing 25 wt % basic copper carbonate and 0.5 wt % tebuconazole was obtained with an average particle size of 0.200 micrometers. 10.0 grams CO₂ was then sparged into the dispersion to adjust the pH to 6.0.

### EXAMPLE 4

300 grams of copper 8-hydroxyquinolate (Cu-8) and 100 g boric acid were mixed with 755 grams of water and 45 grams of dispersants. The mixture was mechanically mixed for about 5 minutes and placed in a grinding mill. The mixture was ground for about 30 minutes and a stable dispersion containing 25wt % Cu-8 was obtained with an average particle size of 0.282 micrometers.

### EXAMPLE 5

A stable cupric oxide (CuO) dispersion containing about 30wt % CuO was supplied by Nanophase Technologies, Inc. The average particle size was about 0.1 micrometers. This dispersion can be mixed with organic soluble or micronized biocides. It can further be mixed with an acid or otherwise acidified to form a stable dispersion with a pH of seven or lower.

### EXAMPLE 6

38.5 g of cupric hydroxide dispersion from Example 1 was mixed with 7.5 g of N,N-dimethyl-1-dodecylamine-N-oxide (AO) and 2954.0 g of water to produce a preservative treating fluid containing 0.385 wt % cupric hydroxide and 0.25 wt % AO. The fluid was then used to treat 2″×4″×10″ samples of southern pine sapwood, and sealed with epoxy resin, using an initial vacuum of 28″ Hg for 15 minutes, followed by a pressure cycle of 135 psi for 25 minutes and a final vacuum of 27″ Hg for 10 minutes. The resulting treated wood was weighed and found to have doubled its weight. The treated sample was cut and the cross sections sprayed with a copper indicator to determine copper penetration following the procedure described in American Wood Preservers' Association Standard A3-00, and the blue color indicates the presence of copper. The sample was found to have 100% uniform distribution of copper throughout the cross section.

### EXAMPLE 7

50.0 g CuO dispersion from Example 5 were mixed with 2942.5 g of water and 7.5 g of didecyldimethylammonium chloride, a water-soluble biocide. The product was mixed until uniformly dispersed and then 5.0 g of CO₂ was sparged to the treating fluid to give a pH of 6.5. A southern pine stake measuring 1.5″×3.5″×10″ was placed in a laboratory retort with a vacuum of 27″ Hg for 15 minutes. The treating solution was then pumped into the retort and the retort pressurized to 130 psi for 30 minutes. The solution was drained from the retort and the test stake weighed. Based on the weight pickup, the test stake doubled its weight and showed uniform penetration of the cupric oxide throughout the wood cross section. A sample taken from the center portion of the treated wood was submitted for scanning electron microscopy (SEM) analysis, and the SEM result indicated a uniform particle distribution in wood.

### EXAMPLE 8

4000 g of treating fluid containing 0.31 wt % of cupric oxide and 0.16 wt % didecyldimethylammonium carbonate, a water-soluble biocide, were prepared by mixing CuO dispersion from Example 5 and didecyldimethylammonium carbonate. Prior to the treatment, 80.0 g of boric acid was added to the treating fluid and mixed until boric acid was dissolved. The fluid was used to treat 2″×4″×10″ southern pine samples by placing the samples in a chamber and drawing a 27″ Hg vacuum for 10 minutes. The treating fluid was then drawn into the chamber and allowed to stay in contact with the wood cubes for 15 minutes. The fluid was pumped from the chamber and the resulting wood had more than doubled its weight. Cross sections of the cubes showed 100% copper penetration.

### EXAMPLE 9

A preservative treating formulation was prepared by adding 0.15 kg of copper carbonate dispersion from Example 2 to 0.025 kg of N, N-dimethyl-1-hexadecylamine-N-oxide and 4.825 kg of water. This fluid was allowed to mix until a homogenous fluid was prepared. This fluid was used to treat southern pine test stakes measuring 0.156×1.5×10.0 inches (4×38×254 mm) by the full-cell process. The resulting stakes showed a uniform distribution of copper throughout the wood cells. The treated test stakes were installed in the field to evaluate the field performance of the preservative following the procedure described in AWPA Standard E7-01 “Standard Method of Evaluating Wood Preservatives by Field Tests with Stakes”. The test results indicated that the treated stakes were resistant to decay and insect attack. The fluid was also used to treat southern pine wood cube blocks measuring ¾″×¾″×¾″ (19 mm×19 mm×19 mm). The treated cubes were exposed to several test fungi to evaluate the bio-efficacy of the preservative formulation following the procedure described in AWPA Standard E10-01 “Standard Method of Testing Wood Preservatives by Laboratory Soil-Block Cultures”. Upon the completion of the soil-block test, the cubes were found to have less than 2.0% weight loss, indicating essentially no fungal attack to the treated cubes. In comparison, untreated wood cubes had approximately 50% weight loss after being exposed to the test fungi. The soil block test results indicated wood treated the above preservative formulation was resistant to fungal attack.

### EXAMPLE 10

A preservative treating composition was prepared by adding 0.1 kg of dispersion from Example 3 to 4.9 kg of water. The resulting fluid contained 0.50% copper carbonate and 0.01 wt % tebuconazole. This fluid was then used to treat full-size lumber using the full-cell process wherein the wood is initially placed under a vacuum of 30″ Hg for 30 minutes, followed by the addition of the treating solution. The system was then pressurized for 30 minutes at 110 psi. A final vacuum of 28″ Hg for 30 minutes was applied to the wood to remove residual liquid. The wood was found to contain a uniform distribution of copper throughout the cross sections and is resistant to fungal and insect attack.

### EXAMPLE 11

54 g of dispersion from Example 3 and 7.5 g of N,N-dimethyl-1-hexadecylamine-N-oxide (AO) were mixed with 2938.5 grams of water to obtain a preservative treating fluid containing 0.45% copper carbonate, 0.009 wt % tebuconazole and 0.25% AO. The resulting fluid was used to treat red pine lumber using a modified full-cell process. The resulting stakes were air-dried and found to a uniform distribution of copper throughout the cross sections and were resistant to fungal and insect attack.

### EXAMPLE 12

A preservative treating fluid was prepared by adding 16.0 g of Cu 8-hydroxyquinolate (Cu-8) dispersion from Example 4 to 3984.0 g of water. The resulting fluid contained 0.1 wt % Cu-8. The fluid was used to treat southern pine lumber using a full cell process. The treated stakes were oven dried and found to contain a uniform distribution of particles throughout the cross sections and were resistant to fungal and insect attack.

### EXAMPLE 13

A preservative treating fluid was prepared by mixing 175 g concentrated dispersion containing 20% copper carbonate and 0.5 wt % cyproconazole with 3325.0 g water. The resulting solution contained a dispersion of 1.0% copper carbonate and 0.025 wt % cyproconazole and was used to treat southern pine lumber using a full cell process. The treated stakes were oven dried and found to contain a uniform distribution of copper and cyproconazole throughout the cross sections and were resistant to fungal and insect attack.

### EXAMPLE 14

A preservative treating fluid can be prepared by mixing copper sulfate solution and micronized cyproconazole at a concentration of 0.25 wt % Cu and 0.01 wt % cyproconazole. The resulting fluid can be used to treat lumber using a full cell process. The treated sample can be air-dried for two weeks and tested for resistance to fungal and termite attack.

Although specific embodiments have been described herein, those skilled in the art will recognize that routine modifications can be made without departing from the spirit of the invention.

We claim:

1. An aqueous wood preservative composition comprising an inorganic compound component selected from the group consisting of a metal, metal compound and combinations thereof and/or an organic biocide component;
wherein the inorganic compound component and/or organic biocide component comprises a dispersion of micronized particles, the pH of the composition is less than 7, and wherein greater than 80 wt percent of the particles are micronized.

2. The composition of claim 1, wherein the composition comprises an organic biocide component selected from the group consisting of biocides listed in Table I.

3. The composition of claim 1 wherein the pH of the composition is in the range of from 5 to 7.

4. The composition of claim 1 wherein the composition comprises an inorganic compound which comprises copper, one or more copper compounds, or combinations thereof.

5. The composition of claim 4, wherein the inorganic compound component is micronized and comprises one or more copper compounds selected from the group consisting of copper hydroxide, copper oxide copper carbonate, basic copper carbonate, copper oxychloride, copper 8-hydroxyquinolate, copper dimethyldithiocarbamate, copper omadine and copper borate.

6. The composition of claim 2, wherein the organic biocide component comprises tebuconazole, propiconazole, cyproconazole, bifenthrin, permethrin, cypermethrin, 2-(thiocyanatomethylthio)benzothiazole, Chlorothalonil, Dichlofluanid, Kathon 930, Kathon WT, Methylisothiazolinone, Benzisothiazolin-3-one, 2-octyl-3-isothiazolone, Imidacloprid, Iodopropynyl Butylcarbamate, Fipronil, Carbendazim or Cyfluthrin.

7. The composition of claim 6, wherein the in organic component is copper carbonate or copper hydroxide and the organic biocide is a compound selected from the group consisting of didecyldimethylammonium chloride, didecyldimethylammonium carbonate, tebuconazole and cyproconazole.

8. The composition of claim 1 wherein greater than 60 wt % of the micronized particles have diameters in the range of 0.05 to 1.0 microns.

9. The composition of claim 2 wherein the composition comprises an organic biocide component which is selected from the group consisting of biocides listed in Table II.

10. The composition of claim 1, further comprising an agent selected from the group consisting of water repellants, colorants, emulsifying agents, dispersants, stabilizers and UV inhibitors.

11. The composition of claim 1, wherein the composition for treating wood further comprises one or more enhancing agents.

12. A method for preserving a wood product comprising the step of contacting the product with the wood preservative composition of claim 1.

13. The method of claim 12, further comprising the step of pressure treating the wood product with the preservative composition.

14. The method of claim 12, wherein the composition comprises a micronized inorganic component and an organic biocide which is either water soluble or micronized.

15. The method of claim 14, wherein the inorganic component comprises one or more copper compounds that are selected from the group consisting of copper hydroxide, copper oxide copper carbonate, basic copper carbonate, copper oxychloride, copper 8-hydroxyquinolate, copper dimethyldithiocarbamate, copper omadine and copper borate; and wherein the organic biocide component comprises tebuconazole, propiconazole, cyproconazole, bifenthrin, permethrin, cypermethrin, 2-(thiocyanatomethylthio)benzothiazole, Chlorothalonil, Dichlofluanid, Kathon 930, Kathon WT, Methylisothiazolinone, Benzisothiazolin-3-one, 2-Octyl-3-isothiazolone, Imidacloprid, Iodopropynyl Butylcarbamate, Fipronil, Carbendazim or Cyfluthrin.

16. The method of claim 12 wherein the pH of the composition is in the range of from 5 to 7.

17. The method of claim 13 wherein greater than 60 wt % of the micronized particles have diameters in the range of 0.05 to 1.0 microns.

18. The method of claim 14 wherein the composition comprises an organic biocide component which is selected from the group consisting of biocides listed in Table 2.

19. The method claim 12, wherein the composition for treating wood further comprises an agent selected from the group consisting of water repellants, colorants, emulsifying agents, dispersants, stabilizers and UV inhibitors.

20. The method of claim 12, wherein the composition for treating wood further comprises one or more enhancing agents.
